(19) United States
(12) Patent Application Publication
(10) Pub. No.: US 2011/0183148 A1
(43) Pub. Date: Jul. 28, 2011

(54) REVERSIBLE ADHESIVE BONDING SYSTEM

(75) Inventors: Hamid G. Kia, Bloomfield Hills, MI (US); Tao Xie, Troy, MI (US); Mark W. Verbrugge, Troy, MI (US)

(73) Assignee: GM GLOBAL TECHNOLOGY OPERATIONS, INC., Detroit, MI (US)

(21) Appl. No.: 12/694,739

(22) Filed: Jan. 27, 2010

(51) Int. Cl. B32B 15/082; B32B 7/10; B32B 27/30; B32B 37/00

(52) U.S. Cl. 428/461; 428/523; 428/522; 156/60

(57) ABSTRACT

An apparatus at which a first substrate having a first surface with a reversible, dry adhesive thereon is releasably attachable includes a second substrate having a second surface, and a member being mounted with respect to the second substrate and defining a third surface. Adherence of the reversible, dry adhesive to the third surface is greater than adherence of the reversible, dry adhesive to the second surface. Accordingly, the member acts as an intermediary interface to improve the adhesion of the first substrate with respect to the second substrate.

### TECHNICAL FIELD

This invention relates to reversible adhesives.

### BACKGROUND OF THE INVENTION

One of the big challenges in the field of reversible adhesives is durability of the bond strength with usage (number of cycles). Adding to the complexity is the substrate surface variation from material to material as well as surface variation for a given material due to contamination or environmental impact.

### SUMMARY OF THE INVENTION

An apparatus is provided at which a first substrate having a first surface with a reversible, dry adhesive thereon is releasably attachable. The apparatus includes a second substrate having a second surface, and a member that is mounted with respect to the second substrate and that defines a third surface. Adherence of the reversible, dry adhesive to the third surface is greater than adherence of the reversible, dry adhesive to the second surface. Accordingly, the member acts as an interface that permits the effective, reversible, adhesive bonding of the first substrate to the second substrate, despite the second substrate's inability to effectively bond with the reversible adhesive.

A corresponding method for improving bonding between a first substrate and a second substrate by a reversible, dry adhesive is provided. The method includes providing a member having a first surface; and mounting the member to the second substrate. The second substrate has a second surface; and adherence of the reversible, dry adhesive to the first surface is greater than adherence of the reversible, dry adhesive to the second surface.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, cross-sectional side view of first and second substrates adhesively bonded to each other via an intermediary interface; and

FIG. 2 is a schematic, cross-sectional side view of alternative first and second substrates adhesively bonded to each other via an alternative intermediary interface.

### DESCRIPTION OF THE PREFERRED EMBODIMENTS

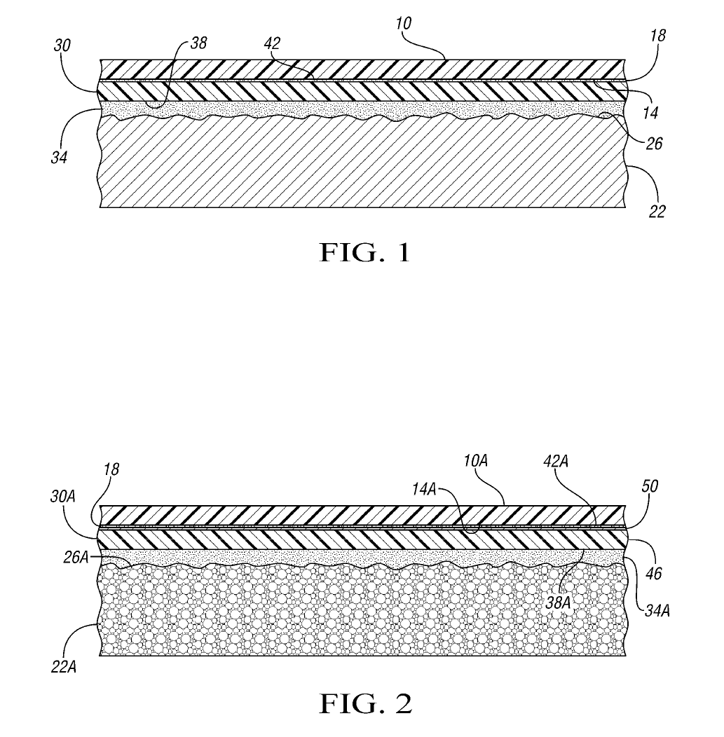

Referring to FIG. 1, a first substrate 10 defines a surface 14 having a reversible, dry adhesive 18 thereon. A second substrate 22 defines a surface 26. Surface 26 is characterized by properties, such as roughness or chemical composition, that result in poor adherence of the reversible, dry adhesive 18 to surface 26.

In order to mount substrate 10 to substrate 22 using adhesive 18, a member 30, which may also be referred to as a “conversion layer,” acts as an interface between the adhesive 18 and the surface 26. More specifically, member 30 is mounted with respect to the second substrate 22. In the embodiment depicted, member 30 is adhesively bonded to surface 26 of substrate 22 by adhesive 34.

Adhesive 34 is conducive to the requirements of the substrate surface 26 and the environment in which the surface 26 is used. That is, adhesive 34 is effective to bond surface 38 of the member 30 to surface 26 of substrate 22. In an exemplary embodiment, adhesive 34 is a curable liquid adhesive, such as epoxy. It may be desirable for adhesive 34 to be permanent, i.e., not reversible.

Member 30 defines surface 42. Surfaces 38 and 42 face opposite directions. Surface 42 is configured such that adherence of the reversible, dry adhesive 18 to surface 42 is greater than adherence of the reversible, dry adhesive 18 to the surface 26 of substrate 22. By acting as an interface between the reversible adhesive 18 and the substrate 22, member 30 permits a user to effectively (and reversibly) mount substrate 10 with respect to substrate 22 using adhesive 18. In the embodiment depicted, member 30 is polymeric. Exemplary materials for member 30 include smooth polystyrene and polymethyl methacrylate.

Referring to FIG. 2, wherein like reference numbers refer to like components from FIG. 1, substrate 22A is human skin. Substrate 10A is part of a medical device. As understood by those skilled in the art, various applications require multiple bonding and de-bonding of a medical device on the skin. For example, substrate 10A may be an ostomy device, an absorbent undergarment or absorbent undergarment liner, a wig, a prosthetic appliance, such as latex ears and noses, prosthetic arm, an insulin pump or insulin pump outlet, etc.

Reversible adhesive 18 is applied to surface 14A of substrate 10A, to releasably and repeatedly attach and detach the substrate 10A with respect to substrate 22A, i.e., skin. As understood by those skilled in the art, characteristics of skin, including contaminants and roughness, may result in poor adhesion between reversible adhesive 18 and the skin surface 26A.

Member 30A provides an interface between skin surface 26A and adhesive 18. More specifically, member 30A is mounted with respect to substrate 22A. In the embodiment depicted, member 30A is adhesively bonded to surface 26A of substrate 22 by adhesive 34A.

Adhesive 34A is a medical adhesive conducive to the requirements of the substrate surface 26A and the environment in which the surface 26A is used. That is, adhesive 34A is effective to bond surface 38A of the member 30A to surface 26A of substrate 22A. Member 30A defines surface 42A. Surfaces 38A and 42A face opposite directions. Surface 42A is configured such that adherence of the reversible, dry adhesive 18 to surface 42A is greater than adherence of the reversible, dry adhesive 18 to the surface 26A of substrate 22A. By acting as an interface between the reversible adhesive 18 and the substrate 22A, member 30A permits a user to effectively (and reversibly) mount substrate 10A with respect to substrate 22A using adhesive 18.

Member 30A of the embodiment of FIG. 2 is ring-shaped and includes two layers 46, 50. Layer 46, which defines surface 38A, is polymeric. Surface 38A is coated with the adhesive 34A for a semi-permanent bonding of the member 30A to the substrate 22A. Layer 50 is metallic foil, and, more specifically, aluminum foil. Layer 50 defines surface 42A, and inhibits moisture penetration from the skin and can be wiped clean from body oil contamination.

In exemplary embodiments, substrates 10 and 10A comprise a shape memory material, and, more particularly, a shape memory polymer. As understood by those skilled in the art, a shape memory material may be characterized by pseudo-plastic strain. Pseudo-plastic strain is similar to plastic strain in that pseudo-plastic strain persists despite removal of the stress that caused the pseudo-plastic strain. Unlike plastic strain, pseudo-plastic strain is reversible by applying an external stimulus to the shape memory material. Depending on the shape memory material, the external stimulus may be heat, electricity, magnetic field, etc. Accordingly, substrates 10 and 10A, if pseudo-plastically deformed prior to attachment to the member 30, 30A, can be easily removed from the member 30, 30A by applying the appropriate external stimulus to reverse the pseudo-plastic strain.

While the best modes for carrying out the invention have been described in detail, those familiar with the art to which this invention relates will recognize various alternative designs and embodiments for practicing the invention within the scope of the appended claims.

1. An apparatus at which a first substrate having a first surface with a reversible, dry, first adhesive thereon is releasably attachable, the apparatus comprising:
a second substrate having a second surface; and
a member being mounted with respect to the second substrate and defining a third surface;
wherein adherence of the reversible, dry, first adhesive to the third surface is greater than adherence of the reversible, dry, first adhesive to the second surface.

2. The apparatus of claim 1, further comprising a second adhesive that adhesively bonds the member to the second substrate.

3. The apparatus of claim 2, wherein the member comprises one of polystyrene and polymethyl methacrylate.

4. The apparatus of claim 1, wherein the second substrate is human skin.

5. The apparatus of claim 4, wherein the member includes a polymeric first layer and a metallic second layer.

6. The apparatus of claim 5, wherein the metallic second layer defines the third surface.

7. The apparatus of claim 6, wherein the reversible, dry first adhesive bonds the first substrate to the third surface.

8. A method of improving bonding between a first substrate and a second substrate by a reversible, dry, first adhesive, the method comprising:
providing a member having a first surface; and
mounting the member to the second substrate;
wherein the second substrate has a second surface; and
wherein adherence of the reversible, dry, first adhesive to the first surface is greater than adherence of the reversible, dry, first adhesive to the second surface.

9. The method of claim 8, wherein said mounting the member to the second substrate includes adhesively bonding the member to the second substrate with a second adhesive.

10. The method of claim 9, wherein the member comprises one of polystyrene and polymethyl methacrylate.

11. The method of claim 8, wherein the second substrate is human skin.

12. The method of claim 11, wherein the member includes a polymeric first layer and a metallic second layer.

13. The method of claim 12, wherein the metallic second layer defines the first surface.

14. The method of claim 13, further comprising adhering the first substrate to the first surface with the reversible, dry, first adhesive.

15. The method of claim 14, wherein the first substrate is a shape memory material.
